(19) United States
(12) Patent Application Publication
(10) Pub. No.: US 2008/0018054 A1
(43) Pub. Date: Jan. 24, 2008

(54) ASPIRATING LABYRINTH SEAL

(75) Inventors: William L. Herron, Springdale, OH (US); Joseph C. Albers, Ft. Wright, KY (US); Christopher C. Glynn, Hamilton, OH (US); Peter Crudgington, Wiltshire (GB)

Correspondence Address: ADAMS EVANS P.A., Suite 2350 Charlotte Plaza, 201 South College Street, CHARLOTTE, NC, 28244, US

(73) Assignee: GENERAL ELECTRIC COMPANY, Schenectady, NY (US)

(21) Appl. No.: 11/458,764

(22) Filed: Jul. 20, 2006

(51) Int. Cl. F16J 15/40

(52) U.S. Cl. 277/409

(57) ABSTRACT

A seal body includes an annular, axially extending portion; a radially extending portion defining a primary seating surface, and cooperating with the axially extending portion to define a generally L-shaped cross section; and at least one annular axially-extending seal tooth.

### BACKGROUND OF THE INVENTION

The present invention relates generally to face seals for rotating machinery, and more particularly to aspirating or gas-balanced face seals.

Face seals are used to minimize leakage through a gap between two components, where such leakage is from a higher pressure area to a lower pressure area. Such seals have been used in rotating machinery, for example steam turbines and gas turbines.

In gas turbines, face seals are used between static hardware, between rotor and stator components, and may be used between different rotating components. The gaps or leakage paths between these different components must be sealed, and the seals applied need to be able to compensate for variations in the gaps due to differential thermal and mechanical component growths during the machine operating cycle.

The variable gap to be sealed is commonly accommodated by either providing a compliant contact that is maintained between the components, for example using a brush seal or a leaf seal, or by creating a complex leakage path which results in pressure losses, and thus a reduced flow, for example with a labyrinth seal. In a labyrinth seal between rotating and static components, extremes in closure of the gap may be accommodated by allowing a rub of rotor labyrinth teeth against a softer stator matrix (“abradable”). Due to the initial gaps, and due to contact of the seals with adjacent surfaces, none of these seals may meet all performance and durability requirements.

As an example, FIG. 1 illustrates a portion of a gas turbine engine including the aft end of a compressor 10, a diffuser 12, an annular combustor 14, and a high-pressure turbine 16 which includes a stationary nozzle 18 and rotating turbine blades 20 carried by a turbine rotor 22. The compressor 10 is driven by the turbine 16 through a shaft 24. The space between the hot gas primary flowpath “F” and the shaft 24 defines a secondary flowpath. For various reasons including maximization of efficiency and avoidance of wear, it is desired to control leakage through the secondary flowpath as much as possible. This is done by including one or more seal assemblies which reduce or block flow therethrough. In the illustrated example, a compressor discharge pressure (CDP) seal assembly 26 including a rotating member 28 having a plurality of radially-outwardly extending annular seal teeth 30 positioned opposite a stationary abradable member 32 is disposed inboard of the diffuser 12. A forward outer seal (FOS) 34 including a rotating member 36 having a plurality of radially-outwardly extending annular seal teeth 38 positioned opposite a stationary abradable member 40 is disposed inboard of the turbine nozzle 18. Face seals are used in other locations in the engine as well. Both the CDP seal assembly 26 and the FOS 34 are subject to deterioration over extended operation as described above.

### BRIEF SUMMARY OF THE INVENTION

The present invention provides a face seal with low leakage and high durability. The clearance between the seal elements is controlled so that the seal teeth will not rub against the seal rotor. This offers efficient sealing both at the time of manufacture of the engine and also after extended time in service. It is estimated that leakage across the primary seal face may be reduced by approximately 25% compared to prior art face seals.

According to one aspect, the invention provides a seal assembly, having: a first annular component defining a generally axially facing first primary sealing surface; and a second annular component defining a generally axially facing second primary sealing surface, the second annular component being mounted in an axially moveable relationship to a seal support such that the second primary sealing surface is disposed facing the first primary sealing surface; wherein at least one of the first primary sealing surface and second primary sealing surface has at least one annular seat tooth extending axially therefrom.

According to another aspect of the invention, a seal body for a seal assembly disposed about an axis includes: an annular, axially extending portion; a radially extending portion defining a primary sealing surface, and cooperating with the axially extending portion to define a generally L-shaped cross section; and at least one annular seal tooth extending axially from the primary sealing surface.

According to another aspect of the invention, a seal assembly disposed about an axis for a gas turbine engine includes: a rotor having an axially facing first primary sealing surface; a stationary seal support disposed adjacent the rotor; an annular seal body attached to the seal support and disposed between the rotor and the seal support, the seal body being axially movable with respect to the seal support, the annular seal body including a generally radially extending portion which defines an axially facing second primary sealing surface which faces the first primary sealing surface, and a generally axially extending portion; wherein at least one of the first primary sealing surface and second primary sealing surface has at least one annular seal tooth extending axially therefrom.

### BRIEF DESCRIPTION OF THE DRAWINGS

The invention may be best understood by reference to the following description taken in conjunction with the accompanying drawing figures in which:

FIG. 1 is a schematic side view of a portion of a prior art gas turbine engine;

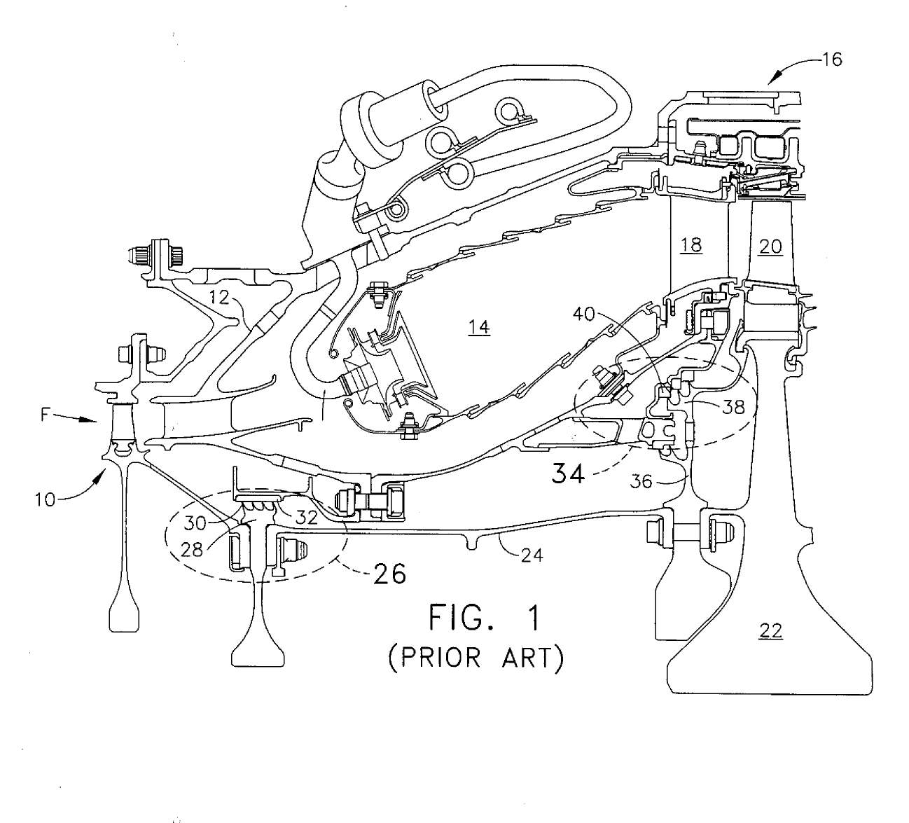

FIG. 2 is a schematic side cross-sectional view of a face seal assembly constructed in accordance with an embodiment of the invention;

FIG. 3 is a front view of a portion of the face seal assembly of FIG. 2;

FIG. 4 is an enlarged sectional view of a portion of the face seal assembly of FIG. 2;

FIG. 5 is another enlarged sectional view of a portion of the face seal assembly of FIG. 2; and

FIG. 6 is a schematic side cross-sectional view of another exemplary face seal assembly.

### DETAILED DESCRIPTION OF THE INVENTION

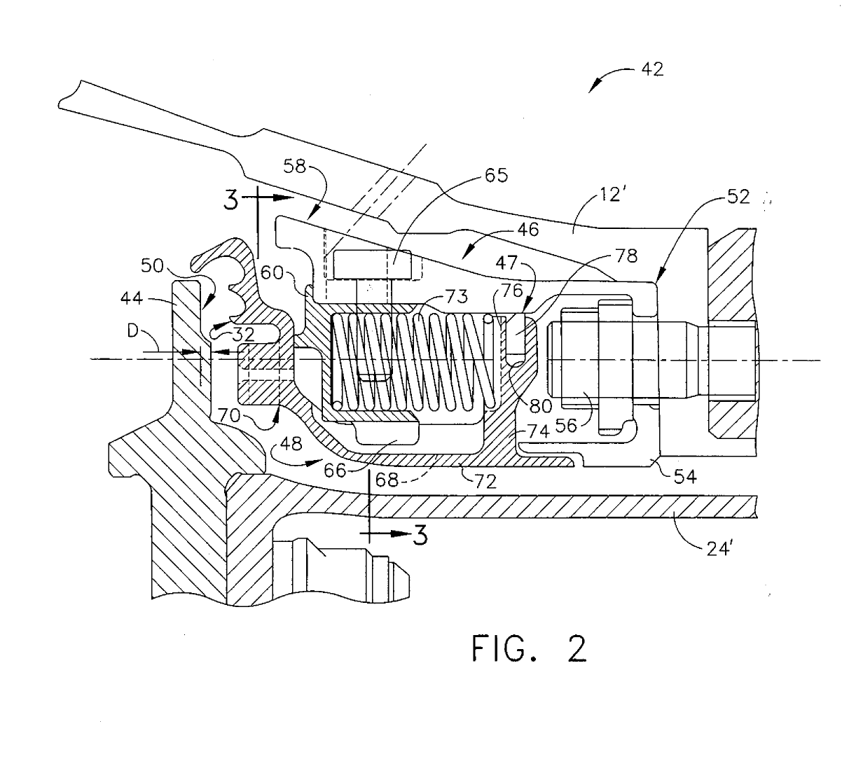

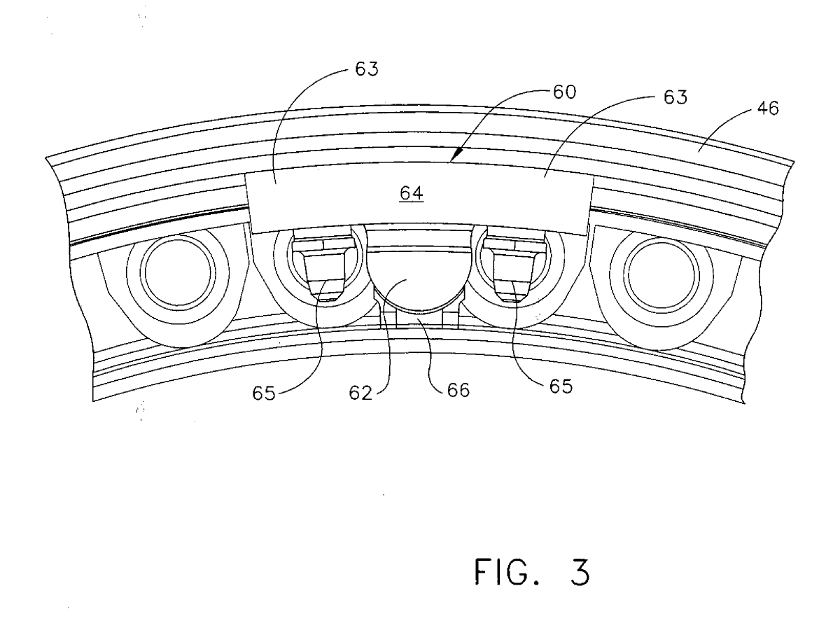

Referring to the drawings wherein identical reference numerals denote the same elements throughout the various views, FIGS. 2 and 3 show an exemplary seal assembly 42 which seals leakage between an area of relatively high pressure P(high) and an area of relatively low pressure P(low). In this particular example, the seal assembly 42 takes the place of a compressor discharge pressure (CDP) seal as described above and is disposed between a core shaft 24′ and a diffuser casing 12′, however it is to be understood that the features of the seal assembly 42 may be used in any application where a face seal is required. The basic components of the seal assembly 42 can include a rotor 44, a stationary seal support 46, and a seal body 48 (sometimes referred to as a “slider”), all disposed about a longitudinal axis of the engine. The rotor 44 is generally disk-shaped and defines a first axially facing primary seal surface 50.

The seal support 46 is a nonrotating, axially-extending component and defines a radially-facing secondary scaling surface 47. In the illustrated example it is a continuous 3600 ring, but it could be configured as a segmented annular structure, or an array of individual supports. Its aft end 52 has a radially-extending flange 54 which is secured to the diffuser 12′ by one or more fasteners 56. Its forward end 58 carries one or more spring seats 60. In this example there are five spring seats equally-spaced around the perimeter of the seal support 46; however the spring seats 60 could alternatively be configured as a continuous or segmented annular structure. As best seen in FIG. 3, the spring seat 60 has a generally cylindrical body 62 and an arcuate flange 64 which defines a pair of laterally-extending mounting ears 63. The spring seat is secured to the seal support 46 by one or more fasteners 65. The body 62 includes a radially-inwardly extending alignment rail 66 which is received in a complementary alignment slot 68 of the seal body 48 to maintain the desired relative angular alignment or “clocking” of the seal support 46 and the seal body 48. The seal body 48 is thus carried by the seal support 46 such that it can move axially but not laterally.

The seal body 48 is an annular component which may be continuous or segmented, and has a generally L-shaped cross section with a radially extending portion 70 and an axially extending portion 72.

A plurality of pullback springs 73 are disposed between the spring seats 60 and a radially-outwardly extending flange 74 of the seal body 48. The aft end of each pullback spring 73 is located in a spring pocket 76 of the flange 74, or other suitable locating feature. The pullback springs 73 serve to displace the seal body 48 away from the rotor 44. This function is described in more detail below. As illustrated, there are five compression-type coil springs, but other types and numbers of springs may be used.

A secondary seal 78, for example a piston ring of a known type, is disposed in a groove 80 in the flange 74, and seals against the axially facing secondary sealing surface 47 of the spring support assembly 46. The piston ring may be of a known type which provides a continuous (or nearly continuous) circumferential seal. The purpose of the secondary seal 78 is to prevent leakage through a path between the seal body 48 and the seal support 46, which is subject to the same pressure differential as the primary seal, while allowing axial movement of the seal body 48. It should be noted that the specific configuration of the seal components and mounting structure described above is not critical and may be varied to suit a particular application without affecting the functional aspects of the seal assembly 42.

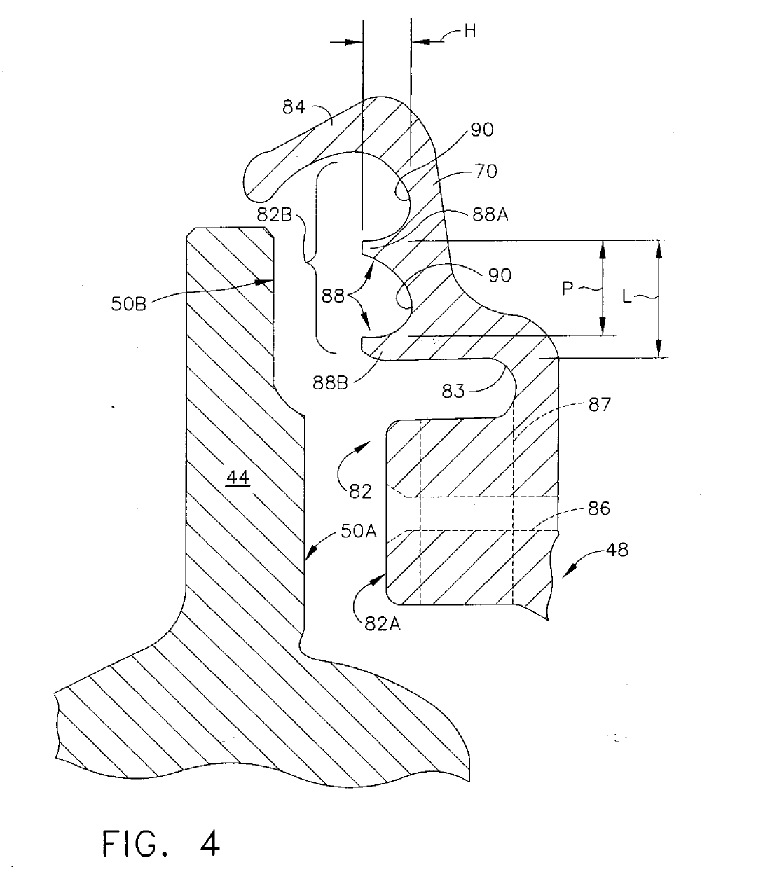

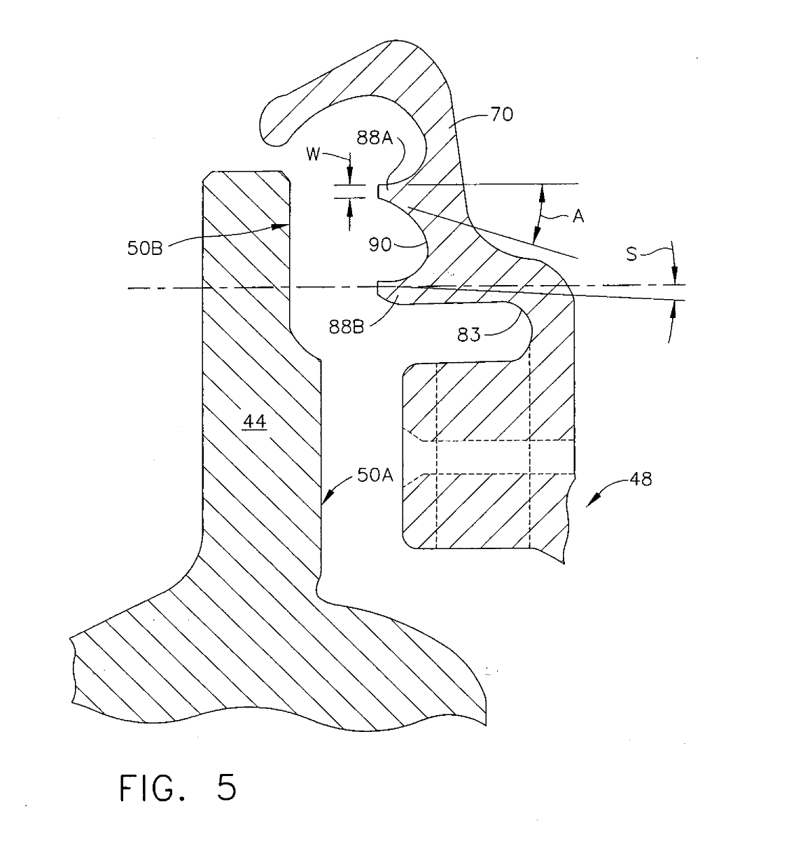

As shown in FIGS. 4 and 5, the radially extending portion 70 of the seal body 48 defines an axially facing second primary sealing surface 82. This second primary sealing surface 82 is disposed in close proximity to the rotor 44 and faces the first primary sealing surface 50. A circumferential seal tooth 84, commonly referred to as a “starter seal”, extends axially from the outer end of the radially extending portion 70, outboard of the rotor 44, and in this particular example, is angled radially inward. Fluid passages 86, 87 are formed through the radially extending portion 70 in a known manner as required for hydrostatic balancing of the seal body 48 in operation (described in more detail below).

The second primary sealing surface 82 includes a planar inner portion 82A and an outer portion 82B, separated by an annular groove 83. The outer portion 82B includes at least one, and optionally a plurality of annular, radially spaced-apart, axially-extending seal teeth 88 which are intended to form a circuitous or tortuous flow path for radial fluid flow, to limit flow from the primary flow path to the secondary flow path. In the illustrated example, there are two seal teeth 88A and 88B with tapered cross-sectional profiles, separated by annular, rounded-bottom grooves 90. The teeth 88 could also protrude from a planar surface if desired. It should also be understood that the seal tooth configuration could be reversed, i.e. the seal teeth 88 could be formed on the first primary sealing surface 50 instead.

The configuration of the second primary sealing surface 82 may be defined in part by various characteristics of the seal teeth 88, including the number of seal teeth 88, their height “H” in an axial direction, their tip width “W”, their included angle in cross-section “A”, their divergence in or out from an axial direction, referred to as a slant angle “S” (note that this angle is very small in the illustrated example), their radial spacing or pitch “P”, and the total radial extent or length of the seal teeth 88, denoted “L”. Nonlimiting examples of these dimensions are as follows: tooth height H about 0.38 mm (0.015 in.), tooth angle A is about 10°, the slant angle S about 0° to about 45°, tip width W about 0.13 mm (0.005 in.) to about 0.76 mm (0.030 in.), and pitch P about 1.3 mm (0.05 in.) to about 3.8 mm (0.15 in.). These values may be altered to suit a specific application.

In the illustrated example, the first primary sealing surface 50 has an inner portion 50A, and an outer portion 503B which is offset axially forward of the inner portion 50A by a distance “D” (see FIG. 2) which is substantially equal to the axial distance from the tips of the seal teeth 88 to the inner portion 82A of the second primary sealing surface 82. With this configuration, a “step” which resists radial flow is defined at the juncture of the inner and outer portions 50A and 50B of the first primary sealing surface 50, and during operation distal portions of seal teeth 88 are disposed axially between the inner and outer portions 50A and 50B of the first primary sealing surface 50.

In operation, the seal body 48 forms a seal in cooperation with the rotor 44. The pullback springs 73 hold the seal body 48 away from the rotor 44 to prevent contact between the two components when the engine is stopped. As the engine operating speed increases, the fluid pressures in the engine's primary and secondary flowpath areas increase, and accordingly the seal assembly 42 is subjected to increasing pressures acting on its axially facing surfaces, the effect of which is to cause the seal body 48 to move towards the rotor 44. By choosing the relative surface areas of the different portions of the seal body 48, the number and dimensions of passages 86, 87, and the dimensions of the pullback springs 73 in a known manner, the seal assembly 42 is hydrostatically pressure balanced at a selected operating condition. Accordingly, the second primary sealing surface 82 never contacts the first primary sealing surface 50, but operates with a small axial clearance, for example about 0.05 mm (0.002 in.) to about 0.13 mm (0.005 in.). The low operating clearance of the aspirating seal assembly 42 combined with the complex flow path through the seal teeth 88 and between the first and second primary sealing surfaces 50 and 82 minimizes leakage.

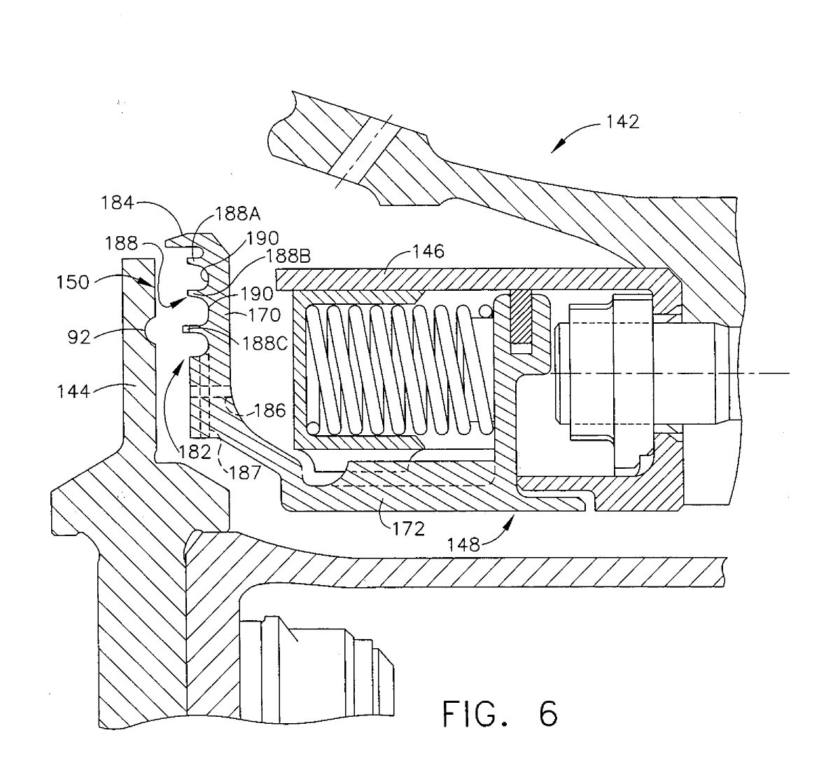

FIG. 6 illustrates another seal assembly 142 including a rotor 144, seal support 146, and seal body 148 with radially and axially extending portions 170 and 172, respectively. This seal assembly 142 is similar in construction to the seal assembly described but differs in the configuration of the first and second primary sealing surfaces 150 and 182. A circumferential starter seal 184, extends axially from the outer end of the radially extending portion 170. Fluid passages 186, 187 may be formed through the radially extending portion 170 in a known manner as required for hydrostatic balancing of the seal body 148.

The second primary sealing surface 182 includes at least one, and optionally a plurality of annular, radially spaced-apart, axially-extending seal teeth 188 which are intended to form a circuitous or tortuous flow path in a radial direction. In the illustrated example, there are three seal teeth 188A, 188B, and 188C with tapered cross-sectional profiles, separated by annular, rounded-bottom grooves 190.

The characteristics of the seat between the first and second primary sealing surfaces 150 and 182 may be altered to suit a specific application in a manner similar to that described above for the seal assembly 48.

An annular seal groove 92 with a rounded bottom is formed in the first primary sealing surface 150. The corresponding seal tooth 188C has a greater height in the axial direction than the other seal teeth 188A and 188B, and will protrude into the seal groove 92 during operation to further reduce leakage.

These seal assemblies offer the complex leakage path of a labyrinth seal, and thus reduce leakage compared to a flat face seal. However, in contrast to prior art labyrinth seals which can rub against the adjacent components, the clearance between the seal elements is controlled so that the seal teeth will not rub against the seal rotor. This offers efficient sealing both at the time of manufacture of the engine and also after extended time in service.

The foregoing has described a face seal assembly. While specific embodiments of the present invention have been described, it will be apparent to those skilled in the art that various modifications thereto can be made without departing from the spirit and scope of the invention.

What is claimed is:

1. A seal body for a seal assembly disposed about an axis, the seal body comprising:
an, axially extending portion;
a radially extending portion defining a primary sealing surface, and extending from the axially extending portion to define a generally L-shaped cross section; and
at least one annular seal tooth extending axially from the primary sealing surface.

2. The seal body of claim 1 wherein at least one of the seal teeth has a tapered cross-sectional profile.

3. The seal body of claim 1 wherein the primary sealing surface includes:
a generally planar inner portion; and
an outer portion which is disposed radially outboard of the inner portion and which carries the seal teeth.

4. The seal body of claim 1 further comprising an annular starter seal extending in a generally axial direction from the primary sealing surface.

5. A seal assembly, comprising:
a first annular component defining a generally axially facing first primary sealing surface; and
a second annular component defining a generally axially facing second primary sealing surface, the second annular component being axially moveable and mounted such that the second primary sealing surface is disposed facing the first primary sealing surface;
wherein at least a selected one of the first primary sealing surface and second primary sealing surfaces has at least one annular seal tooth extending axially therefrom.

6. The seal assembly of claim 5 wherein at least one of the seal teeth has a tapered cross-sectional profile.

7. The seal assembly of claim 5 wherein the other of the first and second primary sealing surfaces includes an annular seal groove therein, the seal groove positioned opposing one of the seal teeth.

8. The seal assembly of claim 5 wherein the selected primary sealing surface includes:
a generally planar inner portion; and
an outer portion which is disposed radially outboard of the inner portion and which carries the seal teeth.

9. The seal assembly of claim 5 further comprising an annular starter seal extending generally axially from the selected primary sealing surface.

10. The seal assembly of claim 5 wherein the second annular component carries a secondary seal which contacts a secondary sealing surface of a stationary seal support.

11. The seal assembly of claim 5 in which the first primary sealing surface has an inner portion, and an outer portion which is offset axially forward of the inner portion such that a step which resists radial flow is defined at a juncture of the inner and outer portions.

12. A seal assembly disposed about an axis for a gas turbine engine, comprising:
a rotor having an axially facing first primary sealing surface;
a stationary seal support disposed adjacent the rotor;
an annular seal body attached to the seal support and disposed between the rotor and the seal support, the seal body being axially movable with respect to the seal support, the annular seal body including:
a generally radially extending portion which defines an axially facing second primary sealing surface which faces the first primary sealing surface, and
a generally axially extending portion;
wherein at least a selected one of the first primary sealing surface and second primary sealing surface has at least one annular seal tooth extending axially therefrom.

13. The seal assembly of claim 12 wherein the seal support defines a radially facing secondary sealing surface.

14. The seal assembly of claim 12 wherein the axially extending portion of the seal body carries a secondary seal which contacts the secondary sealing surface while allowing axial movement of the seal body.

15. The seal assembly of claim 12 wherein at least one of the seal teeth has a tapered cross-sectional profile.

16. The seal assembly of claim 12 wherein the other of the first and second primary sealing surfaces includes an annular seal groove therein, the seal groove positioned opposite of the seal teeth.

17. The seal assembly of claim 12 wherein the second primary sealing surface includes:
a generally planar inner portion; and
an outer portion which is disposed radially outboard of the inner portion and which carries the seal teeth.

18. The seal assembly of claim 12 in which the first primary sealing surface has an inner portion, and an outer portion which is offset axially forward of the inner portion such that a step which resists radial flow is defined at a juncture of the inner and outer portions.

19. The seal assembly of claim 18 in which a distal portion of at least one of the seal teeth is disposed axially between the inner and outer portions of the first primary sealing surface.

20. The seal assembly of claim 12 further comprising an annular starter seal extending generally axially from the second primary sealing surface.

21. The seal assembly of claim 12 further comprising at least one pullback spring disposed between the seal body and the seal support so as to urge the seal body away from the rotor.
